(19) United States
(12) Patent Application Publication
(10) Pub. No.: US 2016/0372869 A1
(43) Pub. Date: Dec. 22, 2016

(54) ASSISTING APPARATUS

(71) Applicant: LOTES CO., LTD, Keelung (TW)

(72) Inventor: Ted Ju, Keelung (TW)

(21) Appl. No.: 14/826,003

(22) Filed: Aug. 13, 2015

(30) Foreign Application Priority Data
Jun. 17, 2015 (CN) 201520417727.X

(51) Int. Cl. H01R 13/64; H01R 12/70

(52) U.S. Cl. CPC H01R 13/64; H01R 12/7076; H01R 12/7082

(57) ABSTRACT

An assisting apparatus for carrying a chip module having a mark, includes a foolproof seat and a clamping apparatus. The foolproof seat has a seat body. The seat body forms, concavely downward, a receiving space for receiving the chip module. The seat body has a first identifier, the clamping apparatus has a second identifier. The clamping apparatus correctly clamps the chip module by aligning the second identifier with the mark and the first identifier. The foolproof seat having the first identifier and the clamping apparatus having the second identifier are provided, the mark is first aligned with the first identifier so that the chip module having the mark is correctly placed inside the foolproof seat, and then the second identifier is aligned with the mark and the first identifier so as to correctly clamp the chip module, thereby avoiding incorrect mounting of the chip module.

### CROSS-REFERENCE TO RELATED APPLICATION

This non-provisional application claims priority under 35 U.S.C. §119(a) on Patent Application No. 201520417727.X filed in P.R. China on Jun. 17, 2015, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates to an assisting apparatus, and in particular, to an assisting apparatus used for carrying a chip module.

### BACKGROUND OF THE INVENTION

A mainboard of each computer is configured with a chip module. The chip module is electrically connected to the mainboard by an electrical connector. The bottom of the chip module is densely provided with multiple contact points. Correspondingly, the electrical connector is internally provided with multiple terminals for contacting the multiple contact points. Certainly, to ensure correct electrical engagement between the chip module and the mainboard, the mainboard is respectively provided with multiple conducting points corresponding to the multiple contact points. In a specific implementation, the electrical connector is first soldered to the mainboard, the multiple terminals are correspondingly soldered to the multiple conducting points, and then the chip module is placed at the electrical connector. When the chip module is placed at the electrical connector, an operator easily mounts the chip module inversely, resulting in that the chip module and the mainboard have an abnormal electrical conduction, and cannot be matched, or slip off, causing damage to the terminals and contact points, or even the chip module being short circuited and burned up. Because the chip module has the highest price in the entire computer, replacement of the chip module causes a high production cost of the entire computer, which adversely affects competitiveness.

Therefore, a heretofore unaddressed need exists in the art to address the aforementioned deficiencies and inadequacies.

### SUMMARY OF THE INVENTION

In one aspect, the present invention relates to an assisting apparatus that identifies a foolproof seat and a clamping apparatus to correctly carry a chip module.

In one embodiment, an assisting apparatus is used for carrying a chip module, the chip module has a mark, and the assisting apparatus includes a foolproof seat and a clamping apparatus. The foolproof seat has a seat body, the seat body forms, concavely downward, a receiving space used for receiving the chip module, and the seat body has a first identifier at a position corresponding to the mark. The clamping apparatus has a second identifier at a position corresponding to the mark and the first identifier. The clamping apparatus clamps the chip module correctly by aligning the second identifier with the mark and the first identifier.

In one embodiment, the seat body is in a shape of a rectangular or square, and has four limiting portions respectively located at four corners. The receiving space is formed between the four limiting portions, and the limiting portions are used for restricting displacement of the chip module. The first identifier is provided at one of the limiting portions.

In one embodiment, the clamping apparatus has a reserved portion corresponding to the limiting portion having the first identifier, and the limiting portion having the first identifier is located inside the reserved portion.

In one embodiment, the clamping apparatus has a reserved portion corresponding to the mark, and the mark is exposed at the reserved portion.

In one embodiment, the seat body has a chamfer, correspondingly, the clamping apparatus is provided with an inclined surface, the chamfer is the first identifier, and the inclined surface is the second identifier.

In one embodiment, the first identifier and the second identifier have a same color, and the color is different from colors of other structures of the foolproof seat and the clamping apparatus.

In one embodiment, the clamping apparatus has a body portion and a supporting portion that are connected. The body portion is provided with a receiving frame used for receiving and positioning the chip module, and the body portion and/or the supporting portion are provided with the second identifier.

In one embodiment, both the body portion and the supporting portion have the second identifier, and the second identifier on the body portion is different from the second identifier on the supporting portion.

In one embodiment, two sides of the clamping apparatus each have a grabbing portion, and correspondingly, two sides of the seat body each have a notched slot.

In one embodiment, the chip module further has at least one notch, the seat body is provided with a positioning block corresponding to the notch, and the positioning block is located inside the notch.

In one embodiment, a bottom surface of the receiving space and/or the seat body are provided with the first identifier corresponding to the mark.

In one embodiment, both the bottom surface of the receiving space and the seat body have the first identifier, and the first identifier on the bottom surface of the receiving space is different from the first identifier on the seat body.

Compared with the related art, certain embodiments of the present invention, among other things, have the following beneficial advantages.

In the assisting apparatus of the present invention, the foolproof seat having the first identifier and the clamping apparatus having the second identifier are provided. The mark is first aligned with the first identifier, and the chip module having the mark is correctly placed inside the foolproof seat. The second identifier is then aligned with the mark and the first identifier, to correctly clamp the chip module, thereby avoiding incorrect mounting of the chip module.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a schematic three-dimensional explode view of a foolproof seat and a chip module in an assisting apparatus according to one embodiment of the present invention.

FIG. 2 is a schematic three-dimensional explode view of a chip module being provided at a foolproof seat and a clamping apparatus in an assisting apparatus according to one embodiment of the present invention.

FIG. 3 is a schematic three-dimensional assembly view of an assisting apparatus and a chip module according to one embodiment of the present invention.

FIG. 4 is a schematic three-dimensional explode view of a clamping apparatus clamping a chip module and a foolproof seat in an assisting apparatus according to one embodiment of the present invention.

FIG. 5 is a schematic three-dimensional explode view of a clamping apparatus clamping a chip module and an electrical connection component in an assisting apparatus according to one embodiment of the present invention.

FIG. 6 is a partial three-dimensional assembly view of the clamping apparatus in FIG. 5, clamping the chip module, being placed inside the electrical connection component.

FIG. 7 is a three-dimensional assembly view of the clamping apparatus in FIG. 6, clamping the chip module, being placed inside the electrical connection component.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

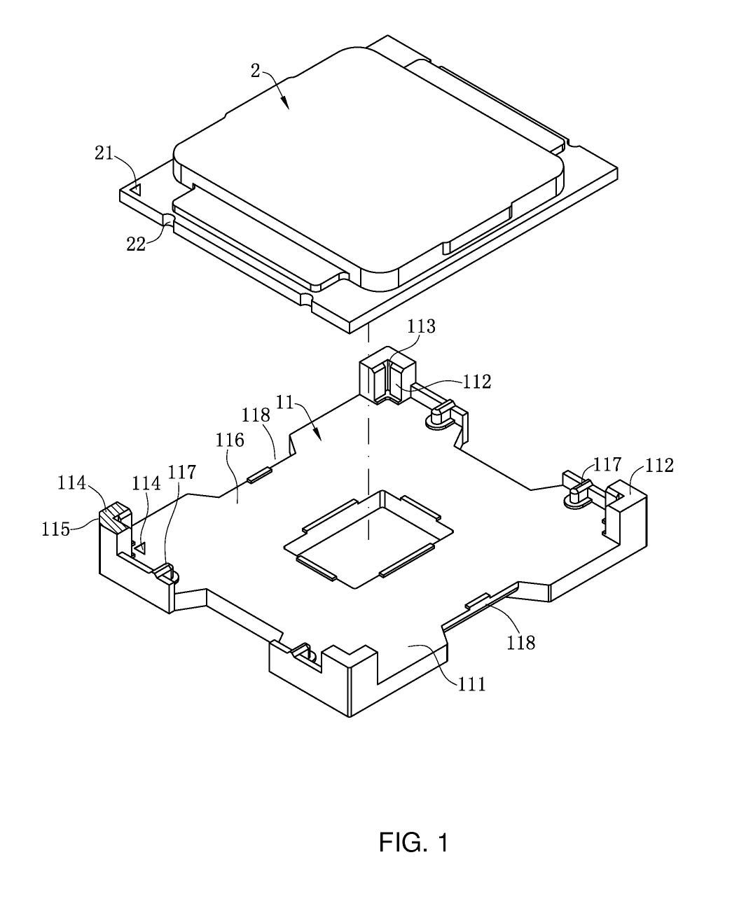

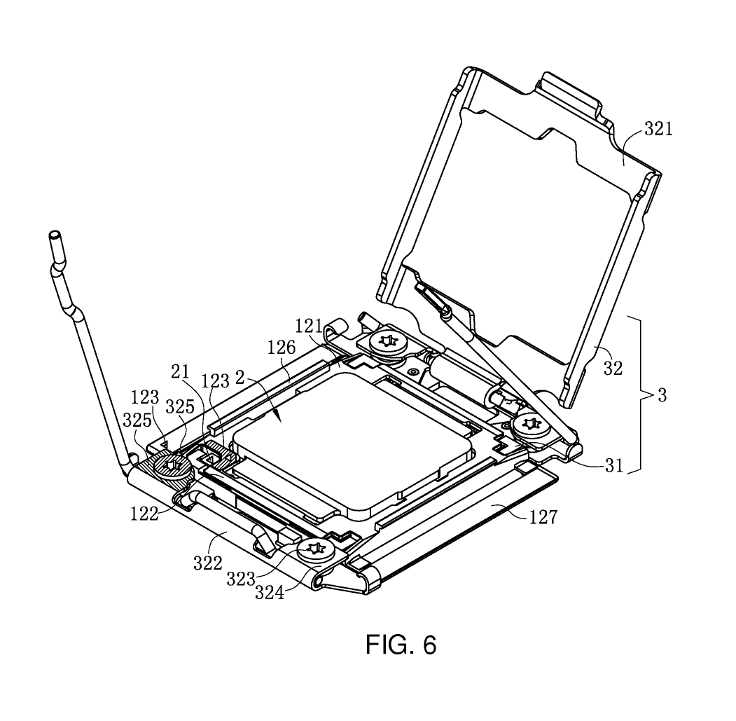

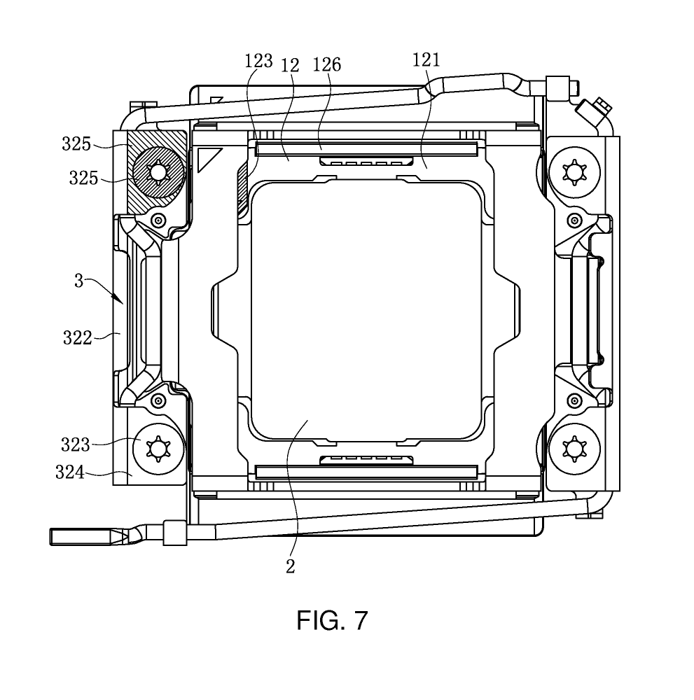

The description will be made as to the embodiments of the present invention in conjunction with the accompanying drawings in FIGS. 1-7. In accordance with the purposes of this invention, as embodied and broadly described herein, this invention, in one aspect, relates to an assisting apparatus.

As shown in FIGS. 1, 2, and 5, an assisting apparatus 1 according to one embodiment of the present invention is used for carrying a chip module 2, and to correctly place the chip module 2 inside an electrical connector assembly 3. The electrical connector assembly 3 is an electrical connector assembly of a land grid array (LGA) package. The electrical connector assembly 3 is used as a bridge to electrically connect the chip module 2 and a circuit board (not shown, same below), so that the chip module 2 and the circuit board are electrically conducted. The chip module 2 is rectangular or square, has a mark 21 at a corner of the chip module 2, and the mark 21 is a triangular sign. Two notches 22 are symmetrically provided on each of two sides of the chip module 2 respectively. Alternatively, in other embodiments, one notch 22 may also be provided on only one side of the chip module 2, or one notch 22 is respectively provided on each of two sides of the chip module 2.

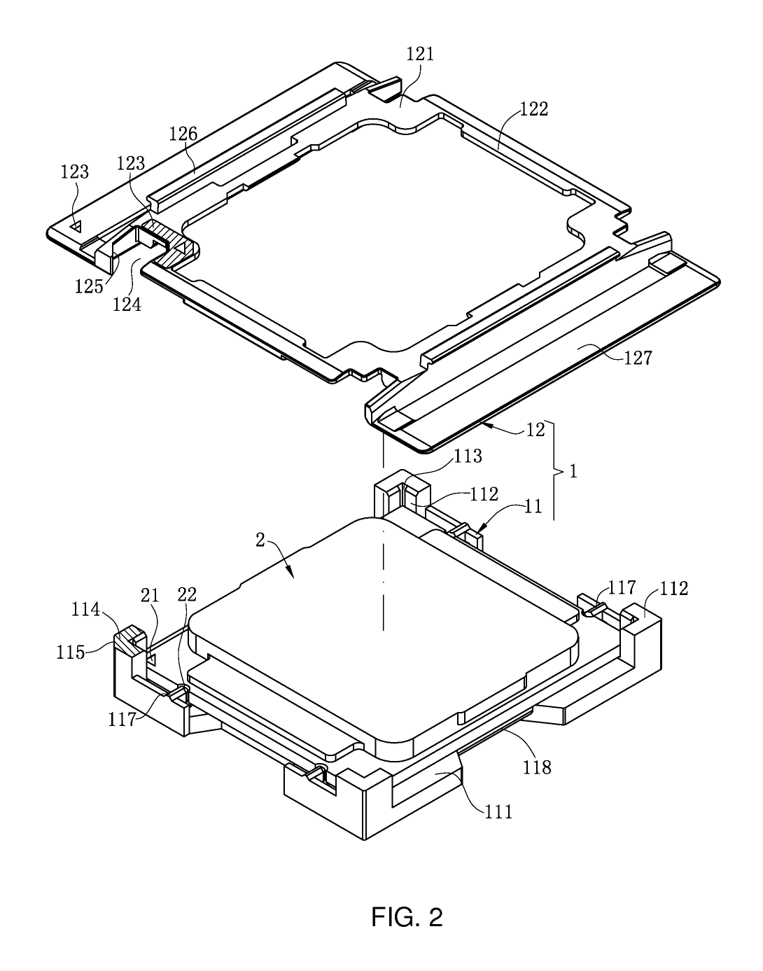

As shown in FIG. 2, the assisting apparatus 1 includes a foolproof seat 11 and a clamping apparatus 12 that are used in combination. The chip module 2 is first placed on the foolproof seat 11, and the clamping apparatus 12 is then used to correspondingly and correctly clamp the chip module 2.

As shown in FIGS. 1 and 2, the foolproof seat 11 has a seat body 111. The seat body 111 is rectangular, and has four limiting portions 112 respectively located at four corners. Each limiting portion 112 has an L-shaped structure, and is provided with a reserved opening 113. A receiving space 116 is formed between the four limiting portions 112. The chip module 2 is assembled downward at the receiving space 116. Four corners of the chip module 2 are correspondingly located inside the four reserved openings 113. The limiting portions 112 are used for restricting displacement of the chip module 2. The reserved openings 113 prevent corners of the chip module 2 from being damaged. One of the limiting portions 112 is provided with a first identifier 114. The first identifier 114 has an L shape. The first identifier 114 is a green object (not shown because a color cannot be shown, same below), and is bonded on an upper surface of the limiting portion 112. When the chip module 2 is correctly assembled at the receiving space 116, the mark 21 corresponds to the first identifier 114, which facilitates observation by an operator, thereby avoiding incorrect mounting.

In other embodiments, the first identifier 114 may also have a non-green color, for example, blue or yellow. Alternatively, the first identifier 114 is a triangular sign, an arrow sign or the like, as long as it is a sign of a remarkable reminder. In one embodiment, the first identifier 114 is coated at the limiting portion 112 or the color of the entire limiting portion 112 is green, as long as the color is different from the colors of other structures of the seat body 111. In one embodiment, as shown in FIG. 1, a bottom surface of the receiving space 116 may also be provided with the first identifier 114 corresponding to the mark 21. That is, there are two first identifiers 114, which are separately provided on the bottom surface of the receiving space 116 and the limiting portion 112. In this way, the reminder is even more remarkable, thereby avoiding incorrect mounting by an operator. The first identifier 114 on the bottom surface of the receiving space 116 and the first identifier 114 on the seat body 111 may be the same or may also be different. In one embodiment, the first identifier 114 is only selectively provided on the bottom surface of the receiving space 116 or the limiting portion 112.

As shown in FIGS. 1 and 2, the seat body 111, at a front side and a rear side, are further symmetrically provided with four positioning blocks 117 corresponding to our notches 22. The positioning blocks 117 are respectively located inside the notches 22 to facilitate positioning and also to avoid incorrect mounting. In other embodiments, there is only one notch 22, and there is also only one positioning block 117. The number of the notches 22 corresponds to the number of the positioning blocks 117. A left side and a right side of the seat body 111 respectively have a notched slot 118 to facilitate holding by an operator.

As shown in FIG. 1, additionally, an outer side of the limiting portion 112 having the first identifier 114 is provided with a chamfer 115. The chamfer 115 may also be the first identifier. That is, there are three first identifiers, which are respectively provided on the bottom surface of the receiving space 116, the upper surface of the limiting portion 112, and the outer side of the limiting portion 112. In this way, the reminder is even more remarkable, thereby avoiding incorrect mounting by an operator. In other embodiments, instead of three first identifiers 114, there may be only one first identifier 114, which is selectively provided on the bottom surface of the receiving space 116, the upper surface of the limiting portion 112 or the outer side of the limiting portion 112.

As shown in FIGS. 2-4, the clamping apparatus 12 has a body portion 121 and a supporting portion 127 that are connected. The body portion 121 is provided with a receiving frame 122 used for receiving and positioning the chip module 2. An upper surface of the body portion 121 and an upper surface of the supporting portion 127 are respectively provided with a second identifier 123 at positions corresponding to the mark 21 and the first identifier 114. In this way, the reminder is even more remarkable, thereby avoiding incorrect mounting by an operator. The second identifier 123 has an L shape. The second identifier 123 of the body portion 121 and the second identifier 123 of the supporting portion 127 may be the same or may also be different, and are different in this embodiment. Same as the first identifier 114, the second identifiers 123 are also green objects. Alternatively, in other embodiments, the second identifiers 123 may also be other formats as those of the first identifier 114, as long as they are a remarkable reminders, for example, a non-green color, a triangular sign or an arrow sign.

As shown in FIGS. 2-4, the body portion 121 is provided with a reserved portion 124 at a position corresponding to the limiting portion 112 having the first identifier 114. The limiting portion 112 is located inside the reserved portion 124, making it easy for an operator to observe whether alignment is achieved, so as to avoid incorrect mounting. The body portion 121 is provided with an inclined surface 125 corresponding to the chamfer 115. The chamfer 115 is parallel to the inclined surface 125. The inclined surface 125 is stopped on an outer side of the chamfer 115, and in addition to an effect of a reminder, may further avoid displacement of the clamping apparatus 12 outside the foolproof seat 11. Similarly, the inclined surface 125 may also be the second identifier. That is, there are three second identifiers, which are respectively provided on the upper surface of the body portion 121, the upper surface of the supporting portion 127, and a side of the body portion 121. In this way, the reminder is even more remarkable, thereby avoiding incorrect mounting by an operator. Alternatively, in other embodiments, instead of three second identifiers 123, there may also be only one second identifier 123, which is selectively provided on the upper surface of the body portion 121, the upper surface of the supporting portion 127 or a side of the body portion 121.

As shown in FIGS. 2-4, the first identifier 114 and the second identifier 123 have a same color, and the color is different from colors of the foolproof seat 11 and other structures of the clamping apparatus 12. In this way, the reminder is even more remarkable, thereby avoiding incorrect mounting by an operator. In other embodiments, the first identifier 114 and the second identifier 123 may also have different colors, or different manners of a remarkable reminder. After the chip module 2 is correctly placed in the receiving space 116, the clamping apparatus 12 clamps the chip module 2 correctly by aligning the second identifier 123 with the mark 21 and the first identifier 114. In this case, the first identifier 114 and the mark 21 are both exposed at the reserved portion 124. Moreover, in this embodiment, the second identifier 123 located on the upper surface of the body portion 121 and the first identifier 114 located on the upper surface of the limiting portion 112 both have an L shape, are disposed opposite to each other, and approximately form a quadrilateral enclosing the mark 21 inside thereof, and are all bonded green objects.

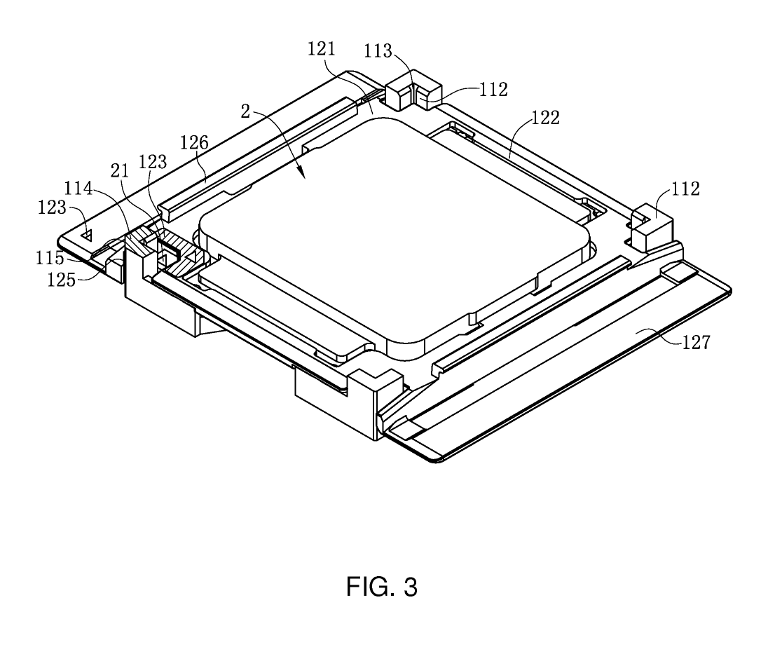

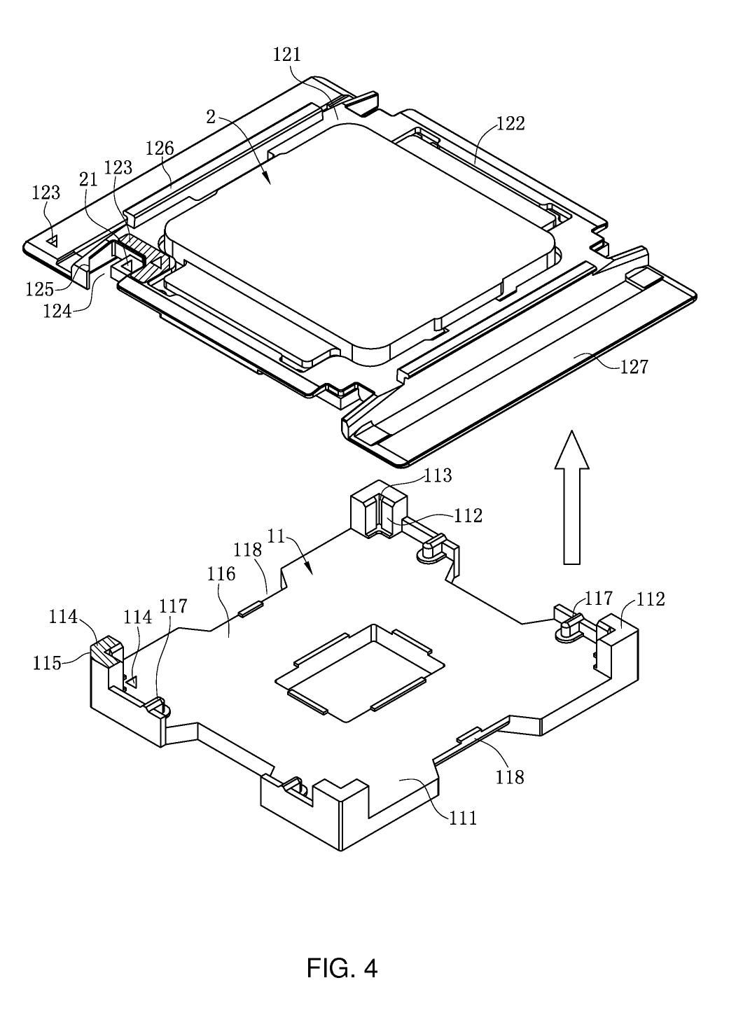

As shown in FIGS. 3 and 4, additionally, the notched slots 118 corresponding to a left side and a right side of the clamping apparatus 12 respectively each have a grabbing portion 126, which facilitate holding by an operator.

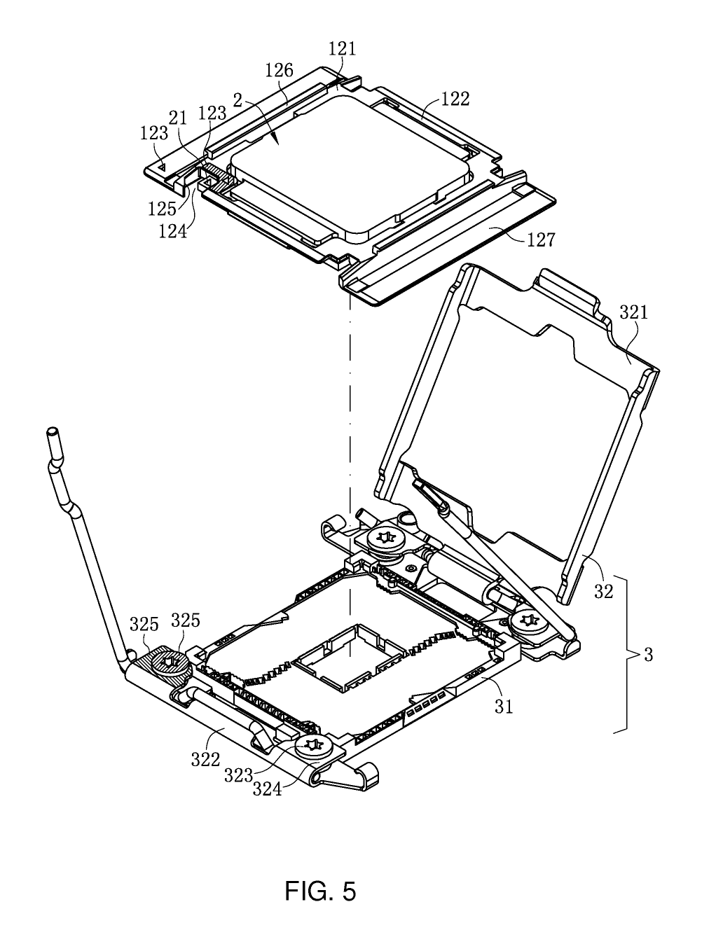

As shown in FIGS. 5-7, the electrical connector assembly 3 includes a socket 31 and a load plate 32 framing an outer side of the socket 31. The socket 31 is located between and electrically conducted to the chip module 2 and the circuit board. The load plate 32 has a pressing member 321 and a mounting member 322 that engage with each other for fixing, and the mounting member 322 is fixed to the circuit board. The pressing member 321 has an open position and a close position relative to the mounting member 322. The mounting member 322 has a third identifier 325. The mounting member 322 further has multiple fixing members 323 and a positioning rack 324. The fixing members 323 are used for fixing the positioning rack 324 to the circuit board. There are two third identifiers 325, which are respectively disposed on the positioning rack 324 and one of the fixing members 323. In this way, the reminder is even more distinct, thereby avoiding incorrect mounting by an operator. Alternatively, in other embodiments, instead of two third identifiers 325, there may also be only one third identifier 325, which is selectively provided on the positioning rack 324 or the fixing member 323. In one embodiment, same as the second identifier 123 and the first identifier 114, the third identifier 325 is also a green object.

As shown in FIGS. 5-7, alternatively, in other embodiments, the third identifier 325 may also be other manners the same as those of the second identifier 123 and the first identifier 114, as long as it is a remarkable reminder, for example, a non-green color, a triangular sign, an arrow sign or the like. In one embodiment, the third identifier 325 is not completely identical with or is completely different from the second identifier 123 and the first identifier 114. For example, the first identifier 114 and the second identifier 123 are the same, but the third identifier 325 and the first identifier 114 are different, or the first identifier 114, the second identifier 123, and the third identifier 325 are all different from each other.

FIGS. 4-7 show a manner of assembly and operations as follows. The socket 31 is first soldered to the circuit board. The load plate 32 is then mounted to the outer side of the socket 31. The multiple fixing members 323 are used to fix the positioning rack 324 to the circuit board, and the pressing member 321 is kept at the open position. Meanwhile, the foolproof seat 11 is provided, and the mark 21 is aligned with the first identifier 114 to correctly mount the chip module 2 to the receiving space 116. Next, the second identifier 123 is further aligned with the mark 21 and the first identifier 114, so that the clamping apparatus 12 correctly clamps the chip module 2. After the clamping apparatus 12 correctly clamps the chip module 2, the foolproof seat 11 is then removed. Subsequently, by clamping the chip module 2 with the clamping apparatus 12, and align the mark 21 and the second identifier 123 with the third identifier 325, the chip module 2 is correctly placed on the socket 31. Finally, place the pressing member 321 at the close position. The pressing member 321 presses the body portion 121, the supporting portion 127, and the chip module 2 downwards, so that the pressing member 321 fixes the clamping apparatus 12 and the chip module 2 together on the socket 31 and the circuit board.

As shown in FIGS. 4-7, the mark 21, the first identifier 114, the second identifier 123, the third identifier 325, the chamfer 115, and the inclined surface 125 all provide an operator with a remarkable reminder, thereby avoiding incorrect mounting of the elements. Therefore, the structures, shapes, and manners of those components do not need to be all the same. For example, the mark 21 may be different from the first identifier 114 and the second identifier 123, but the first identifier 114 and the second identifier 123 may be the same. Moreover, not all of those components need to be exist. For example, the chamfer 115 and the inclined surface 125 may be omitted. The bottom line is that a remarkable reminder is provided.

In conclusion, beneficial advantages of the assisting apparatus 1 according to certain embodiments of the present invention are as follows.

The foolproof seat 11 having the first identifier 114 and the clamping apparatus 12 having the second identifier 123 are provided. The mark 21 is first aligned with the first identifier 114, and the chip module 2 having the mark 21 is correctly placed inside the foolproof seat 11. The second identifier 123 is then aligned with the mark 21 and the first identifier 114, so as to correctly clamp the chip module 2, thereby avoiding incorrect mounting of the chip module 2. The foolproof seat 11 is removed. The mark 21 and the second identifier 123 are aligned with the third identifier 325, so that the chip module 2 is correctly placed at the socket 31, thereby preventing the socket 31 and the chip module 2 from being damaged or even burned up, and ensuring a smooth and correct electrical connection between the chip module 2 and the circuit board, so that a product cost is reduced and competitiveness is enhanced.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An assisting apparatus for carrying a chip module, the chip module having a mark, and the assisting apparatus comprising:
a foolproof seat having a seat body, wherein the seat body forms concavely downward a receiving space for receiving the chip module, and has a first identifier at a position corresponding to the mark; and
a clamping apparatus having a second identifier at a position corresponding to the mark and the first identifier, wherein the clamping apparatus clamps the chip module correctly by aligning the second identifier with the mark and the first identifier.

2. The assisting apparatus according to claim 1, wherein the seat body is rectangular or square, and has four limiting portions respectively located at four corners, the receiving space is formed between the four limiting portions, the limiting portions are used for restricting displacement of the chip module, and the first identifier is provided at one of the limiting portions.

3. The assisting apparatus according to claim 2, wherein the clamping apparatus comprises a reserved portion corresponding to the limiting portion having the first identifier, and the limiting portion having the first identifier is located inside the reserved portion.

4. The assisting apparatus according to claim 1, wherein the clamping apparatus comprises a reserved portion corresponding to the mark, and the mark is exposed at the reserved portion.

5. The assisting apparatus according to claim 1, wherein the seat body comprises a chamfer, the clamping apparatus comprises an inclined surface corresponding to the chamfer, the chamfer is the first identifier, and the inclined surface is the second identifier.

6. The assisting apparatus according to claim 1, wherein the first identifier and the second identifier have a same color, and the color is different from colors of other structures of the foolproof seat and the clamping apparatus.

7. The assisting apparatus according to claim 1, wherein the clamping apparatus comprises a body portion and a supporting portion that are connected, the body portion is provided with a receiving frame for receiving and positioning the chip module, and at least one of the body portion and the supporting portion is provided with the second identifier.

8. The assisting apparatus according to claim 7, wherein both the body portion and the supporting portion have the second identifier, and the second identifier on the body portion is different from the second identifier on the supporting portion.

9. The assisting apparatus according to claim 1, wherein each of two sides of the clamping apparatus has a grabbing portion, each of two sides of the seat body has a notched slot, and the grabbing portions correspond to the notched slots.

10. The assisting apparatus according to claim 1, wherein the chip module further comprises at least one notch, the seat body is provided with a positioning block corresponding to the notch, and the positioning block is located inside the notch.

11. The assisting apparatus according to claim 1, wherein at least one of a bottom surface of the receiving space and the seat body is provided with the first identifier corresponding to the mark.

12. The assisting apparatus according to claim 11, wherein both the bottom surface of the receiving space and the seat body have the first identifier, and the first identifier on the bottom surface of the receiving space is different from the first identifier on the seat body.
